(19) United States
(12) Patent Application Publication
(10) Pub. No.: US 2009/0136801 A1
(43) Pub. Date: May 28, 2009

(54) REFORMING APPARATUS

(75) Inventor: Hiroki OHKAWARA, Nishikamo-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/279,154

(22) PCT Filed: Mar. 13, 2007
(86) PCT No.: PCT/JP2007/054938

§ 371 Date: Aug. 12, 2008

(30) Foreign Application Priority Data
Mar. 27, 2006 (JP) 2006-084664

(51) Int. Cl. H01M 8/18; C10J 3/68

(52) U.S. Cl. 429/19; 48/76

(57) ABSTRACT

A reformer including a reforming section generating reformed gas from reforming fuel supplied thereto, a combustion section burning combustion fuel supplied thereto with combustion oxidizer gas supplied thereto to heat the reforming section with the combustion gas, a combustion gas flow passage allowing the combustion gas discharged from the combustion section to flow, an oxygen density detecting device provided on the combustion gas flow passage detecting oxygen density in the combustion gas flow passage, and a controller judging the ignition of the combustion section based on the oxygen density detected by the oxygen density detecting device.

### TECHNOLOGICAL FIELD

The present invention relates to a reformer.

### BACKGROUND ART

As one form of reformers, as described in Patent Document 1, there has been know one which is provided with a combustion section 7 where combustion is carried out, an exhaust gas flow passage 10 for exhausting combustion exhaust gas from the combustion section 7, and a limiting current type oxygen sensor element 11 arranged in a flow path of the exhaust gas flow passage 10. In the reformer, a sensor output (A) is read when the sensor element is exposed to the combustion exhaust gas which is in a range of 5 to 10% in oxygen density. If the sensor output (A) is within a predetermined range, the combustion operation can be judged to be a normal combustion operation wherein the combustion is performed in a proper oxygen density range, while if the sensor output (A) is out of the predetermined range, the combustion operation can be judged to be an abnormal combustion operation wherein the combustion is performed in a different oxygen density range. Thus, the inspection of the combustion state can be done easily.

Further, the reformer is provided with combustion operation judging means 13 which is juxtaposed with the combustion section 7 or fuel supply means 9 for judging the occurrence or absence of the combustion operation. The combustion operation judging means 13 detects the combustion operation state based on a combustion signal from detection means (not described) such as a flame detecting device or the like installed at the combustion section 7 or the fuel supply state of the fuel supply means 9 and judges the occurrence or absence of the combustion operation.

As flame detecting devices, as shown in Patent Document 2, there has been known one in which flame detecting means 103 is provided with a flame detection rod in a reforming burner 100 and which supplies hydrogen gas containing fuel gas in the quantity that enables the flame to be detected.

Further, as another flame detecting device, as shown in Patent Document 3, there has been known one which is provided with first flame detecting means (flame rod 34) for detecting that a flame of hydrocarbon-base gas is generated at a combustion section and second flame detecting means (thermocouple 36) for detecting that a flame of mixed gas or hydrocarbon-base gas is generated at the combustion section and which switches the flame detecting means in dependence on modes.

Further, as another form of reformers, as shown in Patent Document 4, there has been known a combustion device which operates to intake the outdoor air by air supply means 17, to burn fuel while the same is supplied by fuel supply means 18, and to exhaust combustion exhaust gas outdoors through an exhaust gas flow passage 5 and which is provided with a limiting current type oxygen sensor 6 in the exhaust gas flow passage 5 to configure a closed circuit by connecting a direct current power supply 7 and output detecting means 8 in series to the limiting current type oxygen sensor 6, so that the intake air quantity by the air supply means 17 can be controlled in response to a signal from the output detecting means 8.
Patent Document 1: Japanese unexamined, published patent application No. 2004-198075
Patent Document 2: Japanese unexamined, published patent application No. 2003-187848
Patent Document 3: Japanese unexamined, published patent application No. 2004-210576
Patent Document 4: Japanese unexamined, published patent application No. 5-164322

### DISCLOSURE OF THE INVENTION

### Problem to be Solved by the Invention

However, in the reformer described in the aforementioned Patent Document 1, the judgment about the occurrence or absence of the combustion operation of the combustion section 7 is made based on the output from the flame detecting device or the fuel supply state of the fuel supply means 9, without using the output from the oxygen sensor element 11. On the other hand, the output from the oxygen sensor element 11 is used to judge whether the combustion is a normal combustion operation or an abnormal combustion operation, on the assumption that the combustion has occurred. That is, the separate detecting devices (detection sensors) are required for respectively performing the checking of the ignition and the observation of the combustion state, causing increases of the device in dimension and cost.

Further, where one described in Patent Document 2 is applied to the flame detecting device of the reformer described in Patent Document 1, there is a risk that the ignition/going-out is unable to detect because in the flame detecting device of the flame rod type in Patent Document 2, the ion current being an object to detect is weak where a gas (hydrogen-rich gas) including hydrogen as the main constituent part is burned.

Further, where one described in Patent Document 3 is applied to the flame detecting device of the reformer described in Patent Document 1, it is possible for the flame detecting device in Patent Document 3 to reliably detect the ignition/going-out, but a problem arises in that the reformer is increased as a whole in dimension and in cost because the flame detecting means becomes complicated.

Further, in Patent Document 4, it is described that the intake air quantity can be controlled based on the output from the limiting current type oxygen sensor 6, but it is not described that the occurrence or absence of the ignition/going-out can be detected.

The present invention has been made for solving the aforementioned various problems, and an object thereof is to detect the ignition of a combustion section more reliably in a reformer without causing the same to increase in dimension and cost.

### Measures for Solving the Problem

In order to solve the aforementioned problems, the feature in construction of the invention according to Claim 1 resides in comprising a reforming section for generating reformed gas from reforming fuel supplied thereto; a combustion section for burning combustion fuel supplied thereto with combustion oxidizer gas supplied thereto to heat the reforming section by the combustion gas; a combustion gas flow passage for allowing the combustion gas discharged from the combustion section to flow; an oxygen density detecting device provided on the combustion gas flow passage for detecting oxygen density in the combustion gas flow passage; and a controller for judging the ignition of the combustion section based on the oxygen density detected by the oxygen density detecting device.

Further, the feature in construction of the invention according to Claim 2 resides in that in Claim 1, the controller judges that the combustion section has been ignited, when the oxygen density detected by the oxygen density detecting device becomes equal to or less than a first judging value after the controller outputs an ignition command to the combustion section.

Further, the feature in construction of the invention according to Claim 3 resides in that in Claim 1 or 2, the controller judges that the combustion section has gone out, when the oxygen density detected by the oxygen density detecting device becomes a second judging value or higher after the combustion section is ignited.

Further, the feature in construction of the invention according to Claim 4 resides in that in any one of Claims 1 to 3, the oxygen density detecting device is arranged downstream of a condenser provided on the combustion gas flow passage.

Further, the feature in construction of the invention according to Claim 5 resides in that in any one of Claims 1 to 4, the oxygen density detecting device is an oxygen sensor capable of detecting oxygen density without the need to heat the oxygen density detecting device.

Further, the feature in construction of the invention according to Claim 6 resides in that in any one of Claims 1 to 5, a temperature sensor is further provided on the combustion gas flow passage in juxtaposed relation with the oxygen density detecting device for detecting the temperature in the combustion gas flow passage and that the controller compensates the oxygen density in the combustion gas flow passage detected by the oxygen density detecting device, based on the temperature in the combustion gas flow passage detected by the temperature sensor.

### EFFECTS OF THE INVENTION

In the invention according to Claim 1 as constructed above, since the controller judges the ignition of the combustion section based on the oxygen density detected by the oxygen density detecting device, it becomes possible to judge the ignition and to observe the combustion state without additionally providing a flame detecting device as is provided in the prior art and without causing the device to increase in dimension and cost.

In the invention according to Claim 2 as constructed above, since in the invention according to Claim 1, the controller judges that the combustion section has been ignited, when the oxygen density detected by the oxygen density detecting device becomes equal to or less than the first judging value after the controller outputs the ignition command to the combustion section, it can be realized to judge the ignition reliably.

In the invention according to Claim 3 as constructed above, since in the invention according to Claim 1 or 2, the controller judges that the combustion section has gone out, when the oxygen density detected by the oxygen density detecting device becomes the second judging value or higher after the combustion section is ignited, it can be realized, in addition to being capable of reliably judging the ignition, also to judge the going-out reliably without causing the device to increase in dimension and cost.

In the invention according to Claim 4 as constructed above, since in the invention according to any one of Claims 1 to 3, the oxygen density detecting device is arranged downstream of the condenser provided on the combustion gas flow passage, there can be obtained an oxygen density in which the influence of steam pressure or steam is further reduced, so that a more precise judgment can be made.

In the invention according to Claim 5 as constructed above, since in the invention according to any one of Claims 1 to 4, the oxygen density detecting device is an oxygen sensor capable of detecting oxygen density without the need to heat the oxygen density detecting device, durability, reliability and starting property (time) can be enhanced in comparison with those in the case that uses an oxygen sensor (for example, zirconia-base oxygen sensor) which needs to be heated.

In the invention according to Claim 6 as constructed above, since in the invention according to any one of Claims 1 to 5, the controller compensates the oxygen density in the combustion gas flow passage detected by the oxygen density detecting device, based on the temperature in the combustion gas flow passage detected by the temperature sensor which is provided in juxtaposed relation with the oxygen density detecting device, there can be obtained an oxygen density which is further reduced in the influence of steam pressure, so that a more precise judgment can be made.

### BRIEF DESCRIPTION OF THE DRAWINGS

FIG. 1 is a schematic view showing the outline of one embodiment of a fuel cell system to which a reformer according to the present invention is applied.

FIG. 2 is a block diagram representing the reformer shown in FIG. 1.

FIG. 3 is a flow chart of a control program executed by a controller shown in FIG. 2.

FIG. 4 a flow chart of another control program executed by the controller shown in FIG. 2.

### DESCRIPTION OF REFERENCE SYMBOLS

10 . . . fuel cell, 11 . . . fuel pole, 12 . . . air pole, 20 . . . reformer, 21 . . . reforming section, 22 . . . evaporation section, 22a . . . temperature sensor, 23 . . . carbon monoxide shift reaction section (CO shift section), 23a . . . temperature sensor, 24 . . . carbon monoxide selective oxidizing reaction section (CO selective oxidizing section), 25 . . . burner (combustion section), 31 . . . reforming fuel supply pipe, 32 . . . fuel valve, 33 . . . fuel pump, 34 . . . desulfurizer, 35 . . . reforming fuel valve, 37 . . . combustion fuel supply pipe, 37a . . . combustion fuel valve, 38 . . . CO oxidizing air supply pipe, 38a . . . oxidizing air pump, 38b . . . oxidizing air valve, 41 . . . steam supply pipe, 41a . . . temperature sensor, 42 . . . feedwater pipe, 43 . . . reforming water pump, 44 . . . reforming water valve, 51 . . . reformed gas supply pipe, 51a . . . first reformed gas valve, 52 . . . offgas supply pipe, 52a . . . offgas valve, 53 . . . bypass pipe, 53a . . . second reformed gas valve, 54 . . . cathode air supply pipe, 55 . . . exhaust pipe, 56 . . . combustion gas flow passage, 56a . . . condenser, 56b . . . oxygen sensor (oxygen density detecting device), 56c . . . temperature sensor (temperature detecting device), 57 . . . combustion air supply pipe, 57a . . . combustion air pump, 57b . . . combustion air valve, 60 . . . controller, L1 . . . first line, L2 . . . second line, Sf . . . fuel supply source, Sw . . . water tank.

### PREFERRED EMBODIMENT FOR PRACTICING THE INVENTION

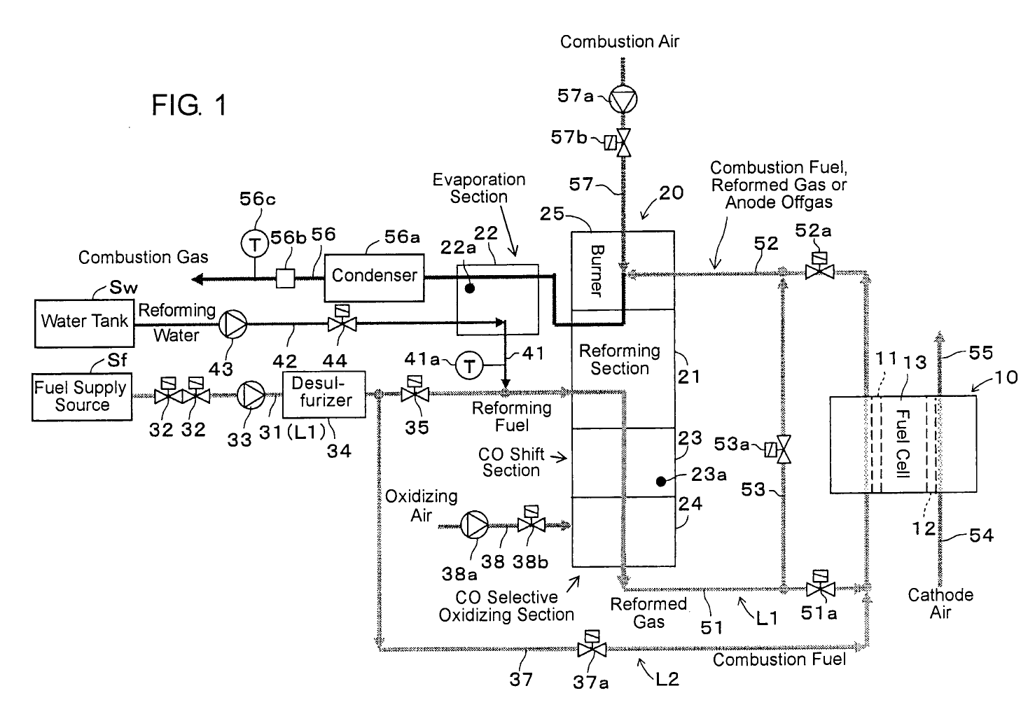

Hereafter, description will be made regarding one embodiment of a fuel cell system to which a reformer according to the present invention is applied. FIG. 1 is a schematic view showing the outline of the fuel cell system. The fuel cell system is provided with a fuel cell 10 and a reformer 20 for generating reformed gas containing hydrogen gas needed for the fuel cell 10.

The fuel cell 10 is provided with a fuel pole 11, an air pole 12 being an oxidizing pole, and electrolyte 13 interposed between both of the poles 11, 12 and is operable to generate electric power by using reformed gas supplied to the fuel pole 11 and air (cathode air) being oxidizer gas supplied to the air pole 12. Instead of air, there may be supplied oxygen-rich air gas.

The reformer 20 is for reforming fuel with steam to supply hydrogen-rich reformed gas to the fuel cell 10 and is composed of a reforming section 21, an evaporation section 22, a carbon monoxide shift reaction section (hereafter referred to as “CO shift section”) 23, a carbon monoxide selective oxidizing reaction section (hereafter referred to as “CO selective oxidizing section”) 24, and a burner (combustion section) 25. As the fuel, there may be employed gaseous fuel such as natural gas, LPG or the like or liquid fuel such as kerosene, gasoline, methanol or the like. The present embodiment will be described in the form using natural gas. Of the fuels, one supplied to the reforming section 21 is referred to as reforming fuel, whereas another supplied to the burner 25 is referred to as combustion fuel.

The reforming section 21 generates hydrogen gas and carbon monoxide gas by reforming a mixture gas, that is the mixture of reforming fuel supplied from a fuel supply source Sf (e.g., a city gas pipe) and steam (reforming water) from the evaporation section 22, with catalyzer (e.g., Ru or Ni base catalyzer) filled in the reforming section 21 (a so-called steam reforming reaction). At the same time, the carbon monoxide, generated through the steam reforming reaction, and the steam are metamorphosed into hydrogen gas and carbon dioxide (a so-called carbon monoxide shift reaction). The generated gases (so-called reformed gases) are led to the CO shift section 23.

The reforming section 21 is supplied with reforming fuel from the fuel supply source Sf through the reforming fuel supply pipe 31. The reforming fuel supply pipe 31 is provided thereon with a pair of fuel valves 32, 32, a fuel pump 33, a desulfurizer 34 and a reforming fuel valve 35 in order from the upstream side. The fuel valves 32 and the reforming fuel valve 35 are electromagnetic shaft-off valves for opening and closing the reforming fuel supply pipe 31 in response to commands from a controller 60. The fuel pump 33 is responsive to a command from the controller 60 to regulate the supply quantity of the fuel from the fuel supply source Sf. The desulfurizer 34 removes a sulfur content (e.g., sulfur compound) in the reforming fuel.

Further, a steam supply pipe 41 connected to the evaporation section 22 being a steam supply source is connected to the reforming fuel supply pipe 31 between the reforming fuel valve 35 and the reforming section 21, and the steam from the evaporation section 22 is mixed with the reforming fuel to be supplied to the reforming section 21. Further, the steam supply pipe 41 is connected to a temperature sensor 41a which is steam state detecting means for detecting the temperature of the steam supplied to the reforming section 21. A signal from the temperature sensor 41a is transmitted to the controller 60.

The evaporation section 22 is connected to a feedwater pipe 42 which is connected to a water tank Sw being a reforming water supply source. The feedwater pipe 42 is provided thereon with a reforming water pump 43 and a reforming water valve 44 in order from the upstream side. The reforming water pump 43 supplies the reforming water from the water tank Sw to the evaporation section 22 and regulates the supply quantity of reforming water in response to a command from the controller 60. The reforming water valve 44 is an electromagnetic valve which is responsive to a command from the controller 60 to open or close the feedwater pipe 42. The evaporation section 22 is heated by the combustion gas (or waste heat from the reforming section 21, the CO shift section 23 and the like) thereby to convert the reforming water supplied thereto into steam. The evaporation section 22 is provided with a temperature sensor 22a for detecting the temperature of the evaporation section 22. A signal from the temperature sensor 22a is transmitted to the controller 60.

The CO shift section 23 reacts the carbon monoxide and steam, contained in the reformed gas from the reforming section 21, through catalyzer (e.g., Cu, Zn base catalyzer) filled inside thereof to generate hydrogen gas and carbon dioxide gas. Thus, the reformed gas is reduced in the density of carbon monoxide to be led to the CO selective oxidizing section 24. Further, the CO shift section 23 is provided with a temperature sensor 23a for detecting the temperature of the catalyzer. A signal from the temperature sensor 23a is transmitted to the controller 60.

The CO selective oxidizing section 24 reacts the carbon monoxide remaining in the reformed gas with the CO oxidizing air (air) supplied from the CO oxidizing air supply pipe 38 through catalyzer (e.g., Ru or Pt base catalyzer) filled inside thereof to generate carbon dioxide. Thus, the reformed gas is further reduced (less than 10 ppm) in the density of carbon monoxide and is supplied to the fuel pole 11 of the fuel cell 10.

The CO oxidizing air supply pipe 38 is provided thereon with an oxidizing air pump 38a and an oxidizing air valve 38b in order from the upstream side. The oxidizing air pump 38a supplies the CO selective oxidizing section 24 with the CO oxidizing air from the atmosphere being an air supply source and regulates the supply quantity of the CO oxidizing air in responsive to a command from the controller 60. The oxidizing air valve 38b is an electromagnetic shaft-off valve which is responsive to a command from the controller 60 to open or close the CO oxidizing air supply pipe 38.

The fuel pole 11 of the fuel cell 10 is connected at its inlet port to the CO selective oxidizing section 24 through a reformed gas supply pipe 51, and the fuel pole 11 is connected at its outlet port to the burner 25 through an offgas supply pipe 52. A bypass pipe 53 bypasses the fuel cell 10 to make a direct connection between the reformed gas supply pipe 51 and the offgas supply pipe 52. The reformed gas supply pipe 51 is provided thereon with a first reformed gas valve 51a between a branched point to the bypass pipe 53 and the inlet port of the fuel pole 11. The offgas supply pipe 52 is provided thereon with an offgas valve 52a between a merging point with the bypass pipe 53 and the outlet port of the fuel pole 11. The bypass pipe 53 is provided with a second reformed gas valve 53a thereon.

At the time of a starting operation, in order to avoid supplying the fuel cell 10 with reformed gas, which is high in the density of carbon monoxide, from the CO selective oxidizing section 24, the first reformed gas valve 51a and the offgas valve 52a are held closed, while the second reformed gas valve 53a is held opened. At the time of an ordinary operation, in order to supply the reformed gas from the CO selective oxidizing section 24 to the fuel cell 10, the first reformed gas valve 51a and the offgas valve 52a are held opened, while the second reformed gas valve 53a is held closed.

Further, the air pole 12 of the fuel cell 10 is connected at its inlet port to a cathode air supply pipe 54, so that air (cathode air) is supplied into the air pole 12. Furthermore, the air pole 12 of the fuel cell 10 is connected at its outlet port to an exhaust pipe 55, so that the air (cathode offgas) from the air pole 12 is exhausted outside.

Further, a first line L1 is constituted by the aforementioned reforming fuel supply pipe 31, the reformed gas supply pipe 51 and the offgas supply pipe 52. The first line L1 is a line which communicates the fuel supply source Sf to the burner 25 through the reforming section 21. That is, the first line L1 includes a rout which passes through the reforming fuel supply pipe 31, the reformed gas supply pipe 51, the bypass pipe 53 and the offgas supply pipe 52 without passing through the fuel cell 10 and also includes another route which passes through the reforming fuel supply pipe 31, the reformed gas supply pipe 51 and the offgas supply pipe 52 by way of the fuel cell 10.

Disposed in parallel with the first line L1, there is a combustion fuel supply pipe 37 being a second line L2, which bypasses the reforming section 21 to communicate with the burner 25 by way of the fuel pole 11 of the fuel cell 10. The combustion fuel supply pipe 37 branches off the reforming fuel supply pipe 31 between the desulfurizer 34 and the reforming fuel valve 35 and is connected to the reformed gas supply pipe 51 between the first reformed gas valve 51a and the fuel cell 10. The combustion fuel supply pipe 37 is provided thereon with a first combustion fuel valve 37a. The first combustion fuel valve 37a is an electromagnetic shut-off valve which is responsive to a command from the controller 60 to open and close the combustion fuel supply pipe 37. Thus, a sulfur content is removed by the desulfurizer 34 from the fuel (combustion fuel) from the fuel supply source Sf, and thus, it is possible to supply the fuel to the burner 25 through the second line L2 and the fuel cell 10.

The burner (combustion section) 25 is for burning combustion fuel supplied thereto with combustion oxidizer gas supplied thereto to heat the reforming section 21 by the combustion gas. That is, the burner 25 is for generating the combustion gas which is for supplying heat necessary for the steam reforming reaction. Respective combustible gases from the fuel supply source Sf, the reforming section 21 and the fuel pole 11 of the fuel cell 10 can be supplied to the burner 25, and the burner 25 burns at least one of these combustible gases with combustion air being the combustion oxidizer gas.

Further, a combustion air supply pipe 57 for supplying combustion air is connected to the burner 25. The combustion air supply pipe 57 is provided thereon with a combustion air pump 57a and a combustion air valve 57b in order from the upstream side. The combustion air pump 57a supplies the burner 25 with combustion air which is supplied from the atmosphere being an air supply source and regulates the supply quantity of combustion air in response to a command from the controller 60. The combustion air valve 57b is an electromagnetic shut-off valve which is responsive to a command from the controller 60 to open and close the combustion air supply pipe 57.

Thus, during a period from the time when a system starting operation is initiated to the time when the supply of reforming fuel to the reforming section 21 is initiated, the combustion fuel from the fuel supply source Sf along the second line L2 is supplied to the burner 25 not by way of the reforming section 21 but by way of the fuel pole 11 of the fuel cell 10. During another period subsequent to the supply of reforming fuel to the reforming section 21 to the initiation of an ordinary operation (power generation), the reformed gas from the CO selective oxidizing section 24 is supplied directly to the burner 25 without passing through the fuel cell 10. Then, during the ordinary operation (power generation), the burner 25 is supplied with anode offgas (the reformed gas or unreformed reforming fuel which was supplied to the fuel pole 11 of the fuel cell 10 but not used therein) from the fuel pole 11 of the fuel cell 10.

The combustion gas discharged from the burner 25 is exhausted outside through a combustion gas flow passage 56. The combustion gas flow passage 56 is arranged to heat the reforming section 21 and the evaporation section 22, and the combustion gas heats the reforming section 21 to reach a temperature range for activation of the catalyzer and also heats the evaporation section 22 to generate steam.

A condenser 56a is provided on the combustion gas flow passage 56. The condenser 56a has passed therethrough a coolant pipe supplied with condensed coolant which has been cooled with low-temperature fluid in a reserved hot water tank (not shown), by a radiator or by a cooling fun, so that the steam in the combustion gas is condensed through heat exchange with the fluid. Accordingly, the combustion gas which has passed the condenser 56a is lowered in temperature and remains in a steam saturated state at the temperature.

An oxygen sensor 56b being an oxygen density detecting device is provided downstream of the condenser 56a on the combustion gas flow passage 56. The oxygen sensor 56b is for detecting the oxygen density in the combustion gas flow passage 56. The detection result from the oxygen sensor 56b is transmitted to the controller 60. It is preferable that the oxygen sensor 56b is an oxygen sensor which is capable of detecting oxygen density without the need to heat the oxygen density detecting device. For example, it may be a galvanic cell oxygen sensor, an optical dissolved oxygen sensor or the like. A temperature sensor 56c being a temperature detecting device for detecting the temperature in the combustion gas flow passage 56 is provided downstream of the condenser 56a on the combustion gas flow passage 56. A detection result form the temperature sensor 56c is transmitted to the controller 60. It is preferable that the temperature sensor 56c is provided in juxtaposed relation with the oxygen sensor 56b. This is because it can be done to detect the temperature of the combustion gas detected by the oxygen sensor 56b so that the oxygen density detected by the oxygen sensor 56b can be compensated based on the temperature.

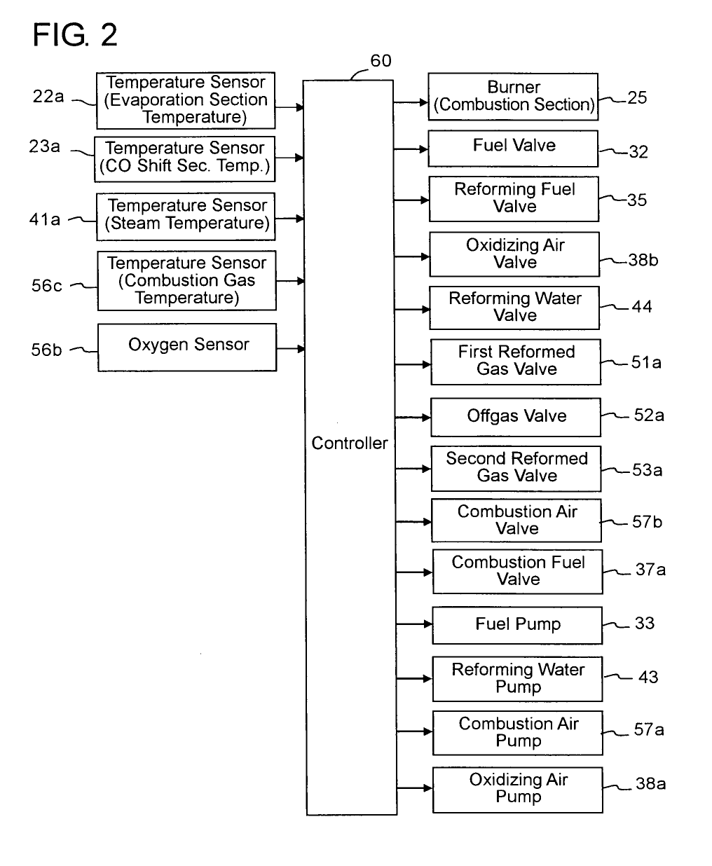

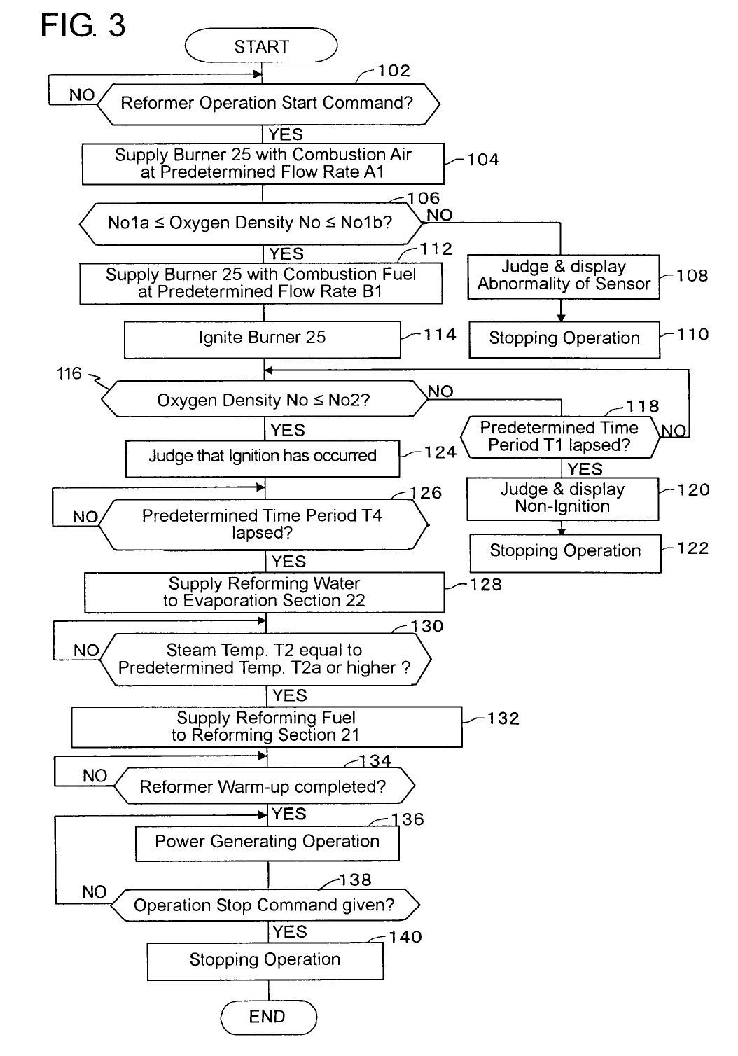

Further, the controller 60 has connected thereto the respective temperature sensors 22a, 23a, 41a, 56c, the oxygen sensor 56b, the respective valves 32, 35, 37a, 38b, 44, 51a, 52a, 53a, 57b, the respective pumps 33, 43, 38a, 57a, and the burner 25 all aforementioned (refer to FIG. 2). The controller 60 incorporates therein a microcomputer (not show), which has an input/output interface, a CPU, a RAM and a ROM (all not shown) connected thereto through bus lines. The CPU executes a program corresponding to a flow chart shown in FIG. 3 and starts the fuel cell system to generate electric power. The RAM temporally stores variables which are necessary to execute the program, and the ROM stores the program.

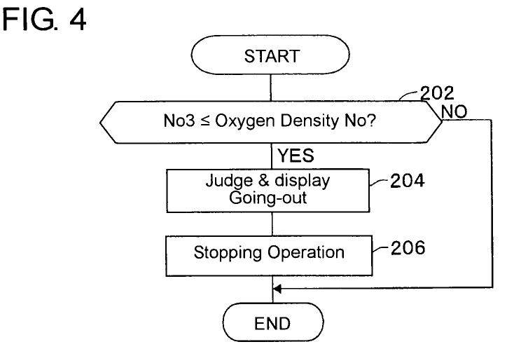

Next, the operation of the fuel cell system as constructed above will be described with reference to the flow charts shown in FIGS. 3 and 4. When a start switch (not shown) is turned on, the controller 30 judges that an operation start command for the reformer 20 has been given (“YES” at step 102) and begins the starting operation.

The controller 60 opens the combustion air valve 66 and drives the combustion air pump 65 to supply the burner 25 with combustion air by a predetermined flow rate A1 for carrying out a purge (step 104).

The controller 60 detects the oxygen density No of the combustion air flowing through the combustion gas flow passage 56, by the oxygen sensor 56b and judges whether the oxygen sensor 56b is normal or not, based on the oxygen density No (step 106). It is preferable to perform the detection of the oxygen density No about when the purge with the combustion air has been effected up to the burner 25.

The oxygen sensor 56b is judged to be normal if the oxygen density No is within a predetermined range, that is, in the range between a lower limit value No1a and an upper limit valve No1b, but is judged to be abnormal if not so. The lower limit value No1a and the upper limit valve No1b are those values which have been determined to have the predetermined range over the atmospheric oxygen density (21%) taken as reference.

If the oxygen density No is out of the predetermined range (“NO” at step 106), the controller 60 judges the oxygen sensor 56b to be abnormal, displays (or announces) the fact (step 108), and stops the starting operation of the fuel cell system (step 110). If the oxygen density No is within the predetermined range (“YES” at step 106), the controller 60 continues the starting operation of the fuel cell system. At this time, the detection value from the oxygen sensor 56b may be calibrated by the atmospheric oxygen density.

The controller 60 opens the fuel valves 32, the combustion fuel valve 37a and the offgas valve 52a with the reforming fuel valve 35 and the first and second reformed gas valves 51a, 53a remaining closed and drives the fuel pump 33 to supply the burner 25 with combustion fuel at another predetermined flow rate B1 (step 112). Then, the controller 60 ignites the burner 25.

The controller 60 detects the oxygen density No of the combustion air flowing through the combustion gas flow passage 56, by the oxygen sensor 56b and judges whether the burner 25 has been ignited or not, based on the oxygen density No (step 116). It is preferable that the detection and judgment of the oxygen density No should be carried out until a predetermined time period T1 lapses which is a sufficient time for the combustion fuel to reach the burner 25. The time being too short may cause the combustion fuel not to reach the burner 25, whereas the time being too long may results in a waste use of combustion fuel.

After the combustion of the burner 25 begins, the combustion air being supplied is consumed with the combustion to lower the oxygen density in the combustion gas flow passage 56. Therefore, a judgment that the combustion is started normally is made if the oxygen density No becomes equal to or less than a predetermined value No2 in the predetermined time period T1, but another judgment that non-ignition has occurred (the ignition and the combustion have not occurred) is made if not so. The predetermined value No2 has been set to be a smaller value (e.g., 15%) than the atmospheric oxygen density (21%).

If the oxygen density No is greater than the predetermined value No2 even after the predetermined time period T1 lapses from the ignition time point of the burner 25 (“NO” and “YES” respectively at steps 116, 118), the controller 60 judges the burner 25 not to have been ignited, displays (or announces) the fact (step 120) and stops the starting operation of the fuel cell system (step 122). It may be executed then to return to step 104 and repeat the ignition operation, wherein if the ignition does not occur even after the repetition of the ignition operation over a predetermined number of times, the system may be stopped and an abnormality may be displayed.

If the oxygen density No becomes equal to or less than the predetermined value No2 until the predetermined time period T1 lapses from the ignition time point of the burner 25 (“YES” at step 116), the controller 60 judges the burner 25 to have been ignited (step 124) and continues the starting operation of the fuel cell system.

When the combustion is started in this way, the reforming section 21 and the evaporation section 22 rise in temperature by being heated by the combustion gas passing through the combustion gas flow passage 56. After a predetermined time period T4 lapses from the ignition time point of the burner 25, the controller 60 opens the reforming water valve 44 and drives the reforming water pump 43 to supply reforming water to the evaporation section 22.

When the temperature T2 of the steam discharged from the evaporation section 22 rises to a predetermined temperature T2a (e.g., 100° C.) or higher, the controller 60 judges that the steam from the evaporation section 22 begins to be supplied to the reforming section 21 (“YES” at step 130). Then, the controller 60 opens the reforming fuel valve 35 and the second reformed gas valve 53a, closes the combustion fuel valve 37a and the offgas valve 52a, and drives the fuel pump 33 to supply reforming fuel to the reforming section 21 at a predetermined flow rate (step 132).

When the reforming fuel is charged into the reforming section 21, the aforementioned steam reforming reaction and the carbon monoxide shift reaction take place therein to generate reformed gas, and the reformed gas is discharged from the CO selective oxidizing section 24. However, since much carbon monoxide is still contained in the reformed gas, the same goes around the fuel cell 10 to be supplied to the burner 25. Further, at the same time as the charging of the reforming fuel, the air valve 64 is opened and the air pump 63 is driven, so that oxidizing air is supplied to the CO selective oxidizing section 24 at a predetermined flow rate. At the CO selective oxidizing section 24, carbon monoxide is further reduced from the reformed gas, which is then discharged from the CO selective oxidizing section 24.

When the temperature T3 of the catalyzer in the CO shift section 23 rises to a predetermined temperature T3a (e.g., 200° C.) or higher, the controller 60 judges that the density of the carbon monoxide in the reformed gas has been lower than a predetermined value, in other words, the starting operation has been terminated (“YES” at step 134). Then, the controller 60 opens the first reformed gas valve 51a and the offgas valve 52a and closes the second reformed gas valve 53a to supply the reformed gas from the CO selective oxidizing section 24 to the fuel cell 10, whereby the fuel cell 10 initiates power generation (step 136).

The controller 60 performs a power generating operation (ordinary operation) at step 136. During the ordinary operation, the controller 60 controls the supply quantities of reforming fuel, combustion air, oxidizing air, cathode air and reforming water so that a desired output current (the electric current and electric power consumed by a load or loads) can be obtained. The supply quantity of reforming fuel has been set to the sum of a supply quantity depending on the desired output electric current and another supply quantity depending on the heat quantity needed for the reforming section 21. The supply quantity of combustion air and the supply quantity of the reforming water have been determined in dependence on the supply quantity of reforming fuel.

Until an operation stop instruction is given by the depression or the like of a stop switch, the controller 60 repeats the judgment of “NO” at step 138 to continue the ordinary operation. Upon the operation stop instruction given, the controller 60 judges “YES” at step 138 to advance the program to step 140 and executes a predetermined stopping operation to stop the operation of the fuel cell system.

Further, the oxygen density detected by the aforementioned oxygen sensor 56b is compensated by the temperature in the fuel gas flow passage 56 which temperature is detected by the temperature sensor 56c at the same time as the oxygen density is detected. Specifically, the controller 60 calculates a saturated steam pressure which is at the temperature detected by the temperature sensor 56c, by reference to a saturated steam pressure curve representing the relation of temperature-saturated steam pressure, and compensates the oxygen density detected by the oxygen sensor 56b by using a value into which the calculated value is converted as density.

In the fuel cell system operating as described above, the controller 60 parallelly executes a going-out detection in accordance with a flow chart shown in FIG. 4 during the period from a time point when the ignition is judged to have occurred normally to another time point when the operation of the fuel cell system is stopped. When the burner 25 goes out, the combustion air and the combustion fuel which are being supplied are discharged from the burner 25 as they are without being burned, and the oxygen density in the combustion gas flow passage 56 increases. Accordingly, the burner 25 is judged to have gone out if the oxygen density No increases to a predetermined value No3 or higher, but is judged to be still burning without going out if not so. The predetermined value No3 has been set to a value (e.g., 20%) which is less than the atmospheric oxygen density (21%) and greater than the predetermined value No2. The predetermined value No3 makes it possible to shorten the time which lapses from the going-out to the judgment of the same if the value is set to be small, but increases the probability that an error may be involved in the judgment, if the value is set to be smaller than it is needed. Thus, it is preferable that the predetermined value No3 is compatible with requirements for responsiveness and reliability.

If the oxygen density No is equal to or higher than the predetermined value No3 (“YES” at step 202), the controller 60 executes an interrupt processing in the course of the processing shown in FIG. 3 to judge that the burner 25 has gone out and to display (or announce) the fact (step 204) and stops the starting operation of the fuel cell system (step 206). If the oxygen density No is less than the predetermined value No2 (“NO” at step 202), the controller 60 continues the processing in accordance with the flow chart shown in FIG. 3.

If the situation is before the reformer warm-up completion (step 134), return may be made after the processing at step 206 to step 104 to repetitively execute the ignition operation. In this case, if the repetition over a predetermined number of times does not result in ignition, the system may be stopped and an abnormality may be displayed. If the situation is after the reformer warm-up completion (step 134), the system is stopped.

Further, in the fuel cell system operating as described above, during the period which lapses from the time point when the ignition is judged to have occurred normally to the time point when the operation of the fuel cell system is stopped, it is preferable to control the flow rate of combustion air as follows. The flow rate of combustion air may be regulated by performing a feedback control of the combustion air pump 57a so that the oxygen density No detected by the oxygen sensor 56b becomes a predetermined value No4. The predetermined value No4 has been set to make the emission satisfy a target value and has also been set taking into account the predetermined value No3 which is for use in judging the aforementioned going-out.

Further, it is preferable to control the flow rate of reforming fuel as follows. The flow rate of reforming fuel may be regulated by performing a feedback control of the fuel pump 33 so that the oxygen density No detected by the oxygen sensor 56b becomes the predetermined value No4. For the flow rate of reforming fuel, there are set upper and lower limit flow rates corresponding to a generated hydrogen quantity range (hydrogen usage rate range) in which the fuel cell is able to generate electric power stably, and the flow rate of reforming fuel is regulated to be included in the range. Thus, it can be realized to reliably detect the ignition (and the going-out) by the oxygen density detecting device only without providing any other detecting device, and it can also be done to control the combustion state appropriately.

The predetermined value No4 has been represented in the form of maps which depend on the kinds of combustion gases used in the burner 25 such as the case that no reheating line is provided because reforming fuel only is burned or the case that anode offgas only is burned, and a control is performed based on the maps for optimum combustion. Further, the predetermined value No4 has also been represented in the form of another map depending on combustion load (power generation load), and another control is performed based on the map for optimum combustion.

As is clear from the foregoing description, in this embodiment, since the controller 60 judges the ignition of the combustion section 25 based on the oxygen density detected by the oxygen sensor 56b being an oxygen density detecting device, it becomes possible to judge the ignition and to observe the combustion state without additionally providing a flame detecting device which the prior art is provided with for detecting ignition, and without causing the device to increase in dimension and cost.

Further, since the controller 60 judges that the combustion section 25 has been ignited, when the oxygen density No detected by the oxygen density detecting device 56b becomes equal to or less than the predetermined value No2 being the first judging value (step 124) after the controller 60 outputs the ignition command (step 114) to the combustion section 25, it can be done to reliably judge the ignition.

Further, since the controller 60 judges that the combustion section 25 has gone out, when the oxygen density No detected by the oxygen density detecting device 56b becomes equal to or greater than the predetermined value No3 being the second judging value after the combustion section 25 is ignited (step 124), it can be done, in addition to being capable of reliably judging the ignition, also to reliably judge the going-out without causing the device to increase in dimension and cost.

Further, since the oxygen density detecting device 56b is arranged downstream of the condenser 56a provided on the combustion gas flow passage 56, there can be obtained an oxygen density from which the influence of steam pressure or steam is further reduced, so that it can be done to make a more precise judgment.

That is, since the combustible gas supplied to the burner 25 may be the combustion fuel supplied from the fuel supply source Sf, may be the reformed gas supplied from the reforming section 21, or may be the anode offgas from the fuel cell 10, the ratio in the constituent parts of the combustible gas changes. Since the ratio in the constituent parts of each of the reformed gas and the anode offgas changes in dependence on the operating state of the reformer 20 or the operating state of the fuel cell 10, the ratio in the constituent parts of the combustible gas changes. Therefore, since the steam density in the combustion gas changes greatly, the influence on the oxygen density value detected by the oxygen sensor 56b is great. Accordingly, creating the saturated state of steam in the condenser 56a and detecting the oxygen density in a stable environment of steam density are very effective measures for precise judgment.

Further, since the oxygen density detecting device 56b is an oxygen sensor which is capable of detecting the oxygen density without the need to heat the oxygen density detecting device 56b itself, durability, reliability and starting property (time) can be improved in comparison with those in the case that uses an oxygen sensor (e.g., zirconia oxygen sensor) which is required to be heated.

Further, since the controller 60 compensates the oxygen density in the combustion gas flow passage 56 detected by the oxygen density detecting device 56b, based on the temperature in the same combustion gas flow passage 56 detected by the temperature sensor 56c, there can be obtained an oxygen density from which the influence of steam pressure is further reduced, so that it can be done to make a more precise judgment.

Although the aforementioned embodiment has been described regarding the fuel cell system which is not provided with a reheating line, the present invention may also be applicable to that which is provided with such a reheating line. The reheating line is a separate line for directly supplying combustion fuel to the burner 25. In this case, combustion fuel is supplied only from the reheating line at the time of the starting operation, and reforming fuel is supplied in the same manner as aforementioned after steam begins to be supplied to the reforming section 21. Then, when the heat quantity to the reforming section 21 runs short, combustion fuel is replenished from the reheating line. At this time, a feedback control may be performed for the flow rate of the combustion fuel from the reheating line so that the oxygen density No detected by the oxygen sensor 56b becomes the predetermined value No4.

Further, also in the foregoing embodiment, a blower may be used in place of the pump for supplying gas.

### INDUSTRIAL APPLICABILITY

As described above, a reformer according to the present invention is suitable for detecting the ignition of a combustion section more reliably.

1: A reformer comprising:
a reforming section for generating reformed gas from reforming fuel supplied thereto;
a combustion section for burning combustion fuel supplied thereto with combustion oxidizer gas supplied thereto to heat the reforming section with the combustion gas;
a combustion gas flow passage for allowing the combustion gas discharged from the combustion section to flow;
an oxygen density detecting device provided on the combustion gas flow passage for detecting oxygen density in the combustion gas flow passage; and
a controller for judging the going-out of the combustion section in an ordinary operation based on the oxygen density detected by the oxygen density detecting device.

2: The reformer as set forth in claim 1, wherein the controller judges that the combustion section has been ignited, when the oxygen density detected by the oxygen density detecting device becomes equal to or less than a first judging value after the controller outputs an ignition command to the combustion section.

3: The reformer as set forth in claim 1, wherein the controller judges that the combustion section has gone out, when the oxygen density detected by the oxygen density detecting device becomes a second judging value or higher after the combustion section is ignited.

4: The reformer as set forth in claim 1, wherein the oxygen density detecting device is arranged downstream of a condenser provided on the combustion gas flow passage.

5: The reformer as set forth in claim 1, wherein the oxygen density detecting device is an oxygen sensor which is capable of detecting oxygen density without the need to heat the oxygen density detecting device.

6: The reformer as set forth in claim 1, wherein a temperature detecting device is further provided on the combustion gas flow passage in juxtaposed relation with the oxygen density detecting device for detecting the temperature in the combustion gas flow passage; and
wherein the controller compensates the oxygen density in the combustion gas flow passage detected by the oxygen density detecting device, based on the temperature in the combustion gas flow passage detected by the temperature detecting device.

7: A fuel cell system comprising:
the reformer as set forth in claim 1; and
a fuel cell for generating electric power when supplied with reformed gas from the reformer;
wherein during an ordinary operation, the combustion section is ignited only with anode offgas supplied from the fuel cell.
